(19) United States
(12) Patent Application Publication
(10) Pub. No.: US 2007/0163932 A1
(43) Pub. Date: Jul. 19, 2007

(54) Operating group for integrated production of energy and desalinated water

(76) Inventor: Bianchi Gianfranco, Genova (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/589,780

(22) PCT Filed: Feb. 20, 2004
(86) PCT No.: PCT/IT04/00074

§ 371 Date: Aug. 17, 2006

(51) Int. Cl. B01D 21/30

(52) U.S. Cl. 210/137; 210/258; 210/175; 210/321.65

(57) ABSTRACT

The invention concerns a multi-purpose operating unit for the combined production of electric power and desalinated water. For this purpose an internal-combustion engine (2) operates an electric generator (10), two pumps (17, 33) for conveying water coming from the outside to osmotic membranes (8, 9): along the water flow path between the first and the second pump (17, 33) the flow is split up so as to maintain 47 predefined pressure conditions at the intake of the second pump (33). This ensures uniform operation of the latter even when there is variation in the number of revolutions of the engine.

The present invention relates to an operating unit for providing various utilities, including the generation of electric power and the desalination of water.

As is known, the on-board production of electric power in boats or land vehicles such as roulettes, vans with a body (camper vans) and the like, is often carried out using special generating units; the latter (shortly called “generators”) are also used in dwellings or fixed installations which cannot be reached by the electric power supply network, such as building yards, camping sites and other installations.

Generating units comprise an internal-combustion engine (usually a diesel engine) which operates an alternator or a dynamo, depending on whether they are intended to generate alternating current or direct current; for the sake of brevity the term “generator” will be used below to indicate irrespectively either the alternator or dynamo of a unit.

Recently the performance and potential uses of generating units have been radically innovated by designing them so as to become multi-purpose, providing them with additional functions such as water desalination or air-conditioning, as described in the European patent application published under number EP 1,120,556, whose applicant is the same of that of the present application.

Before continuing further it should be pointed out that in this description and in the claims which will follow any reference to desalination, desalinators or the osmotic membranes used for desalination, must be understood in the widest sense as referring also to filtration, ultrafiltration and similar water treatment processes; the water may therefore also be sea water (in the case of desalination) or fresh and brackish water.

An important aspect of the multi-purpose operating units considered above is their constructional complexity.

Indeed it is obvious that an increase in the functions carried out also results in an increase in the number of components (pumps, compressors, pipes, valves, etc.) required to perform said functions, thereby inevitably enhancing the complexity of their structure; moreover, since a plurality of functions are carried out (power generation, desalination, air-conditioning conditioning, etc.), the operating conditions vary. frequently owing to the variable demand for electric power, drinking water or cold quantity, which may occur.

In practice this results in operational transients due to switching on and off of the generator, the pump associated with the osmotic membranes or the air-conditioning compressor.

Hitherto for ensuring uniform operation of the unit, the flow of water coming from the outside is divided up among the various functions (desalination, cooling, air-conditioning) so as to ensure operating conditions for each of them which are not influenced by the others.

For example, in the operating unit described in the aforesaid patent application, the water to be desalinated is conveyed to the high-pressure pump which supplies the osmotic membranes, separately from that to the engine cooling circuit.

It is therefore necessary to provide corresponding pipes, outlets, valves and the like, thereby making more complex the structure and installation of the multi-purpose operating unit.

The present invention aims at remedying this situation; namely it has the object of providing an operating unit wherein the path containing the sea, lake, river or other water supplied from outside, is simplified so as to reduce the complexity of the structure, the operation and installation.

This object is achieved by an operating unit which comprises a flow path for the water (to be desalinated, filtered, ultrafiltered, etc.) which extends between a supply pump and a high-pressure pump connected to membranes (for desalination, filtration, ultrafiltration, etc.), and along which the water flow first exchanges heat with the engine in order to cool it and then is divided upstream of the high-pressure pump, maintaining predefined pressure and/or flow rate conditions for the water which reaches it.

In this manner it is possible to arrange in series the heat exchanger for cooling the engine and the membranes, because a greater throughput of water is used for the former than for the latter and the excess of water is discharged, thereby maintaining controlled pressure conditions at the intake of the high-pressure pump.

In accordance with a preferred embodiment of the invention, control of the pressure and/or flow is achieved by providing a discharge duct along the water flow path downstream of heat exchange with the engine, together with means for intercepting the water which flows through this discharge duct.

According to another embodiment, upstream of heat exchange with the engine, the water exchanges heat also with the condenser of an air-conditioning apparatus associated with the unit, and with the exhaust of the internal-combustion engine.

These and further characterising features of the operating unit according to the invention are set forth in the claims which will follow; they will more clearly appear from the description below, relating to a preferred but not exclusive embodiment of the invention illustrated in the accompanying drawings wherein:

FIG. 1 shows a perspective view of an operating unit according to the invention;

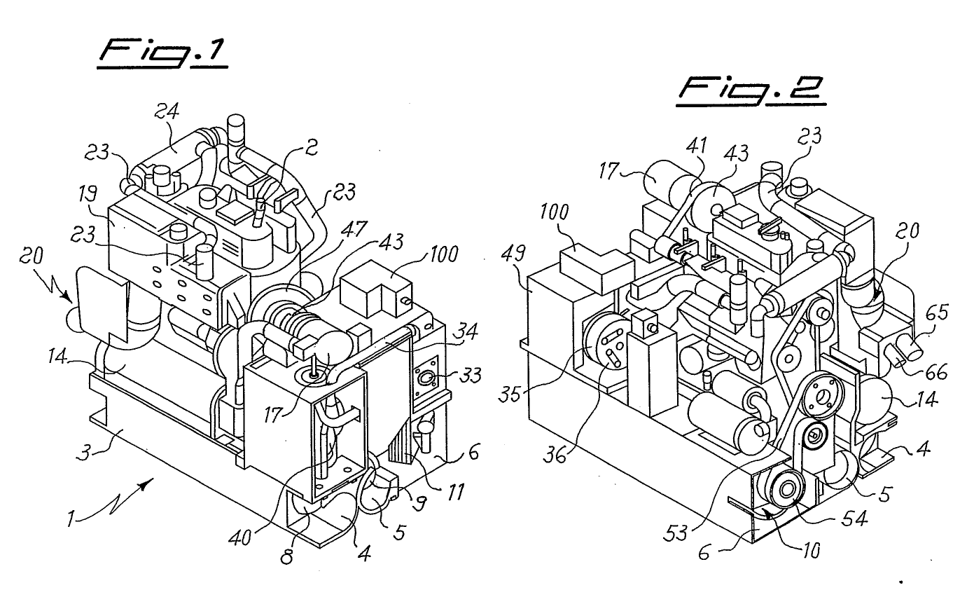

FIG. 2 shows a perspective view of the same operating unit, from the opposite angle to that of FIG. 1;

FIG. 3 is a partially sectioned side view of the operating unit according to FIGS. 1 and 2;

FIG. 4 is a detail of the above operating unit;

FIG. 5 is a diagram which illustrates functioning of the operating unit shown in the preceding figures;

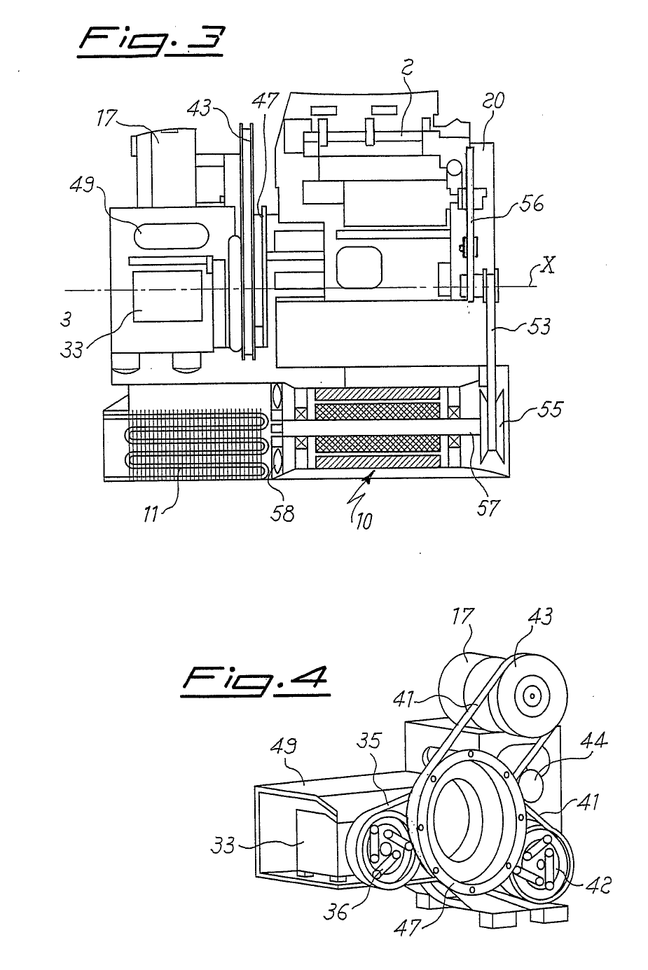

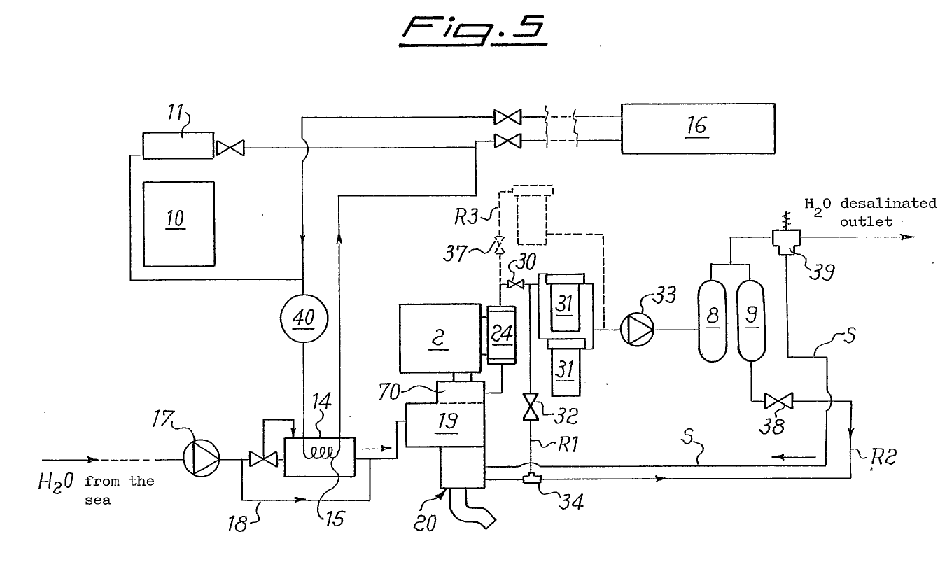

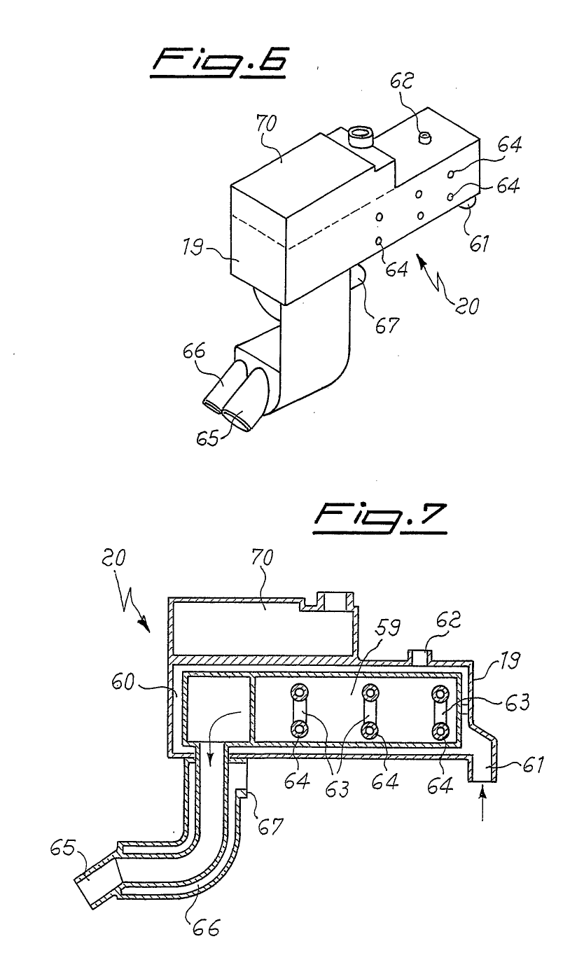

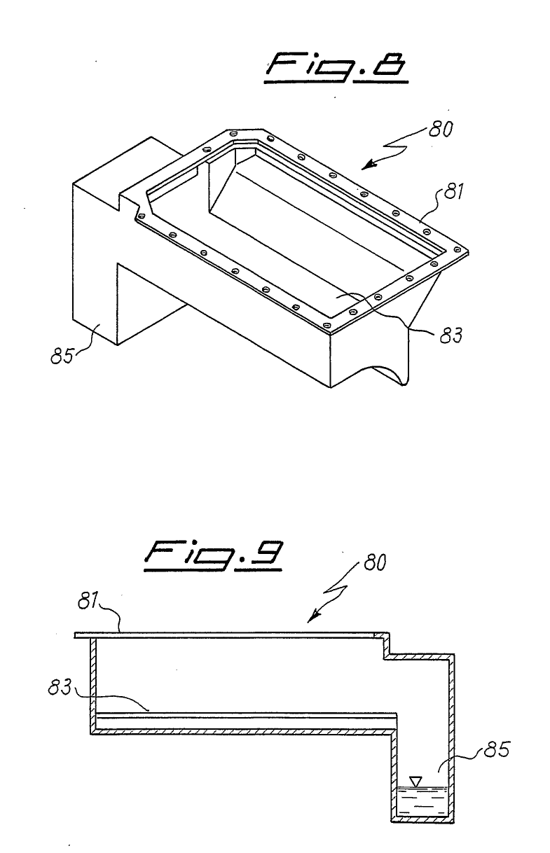

FIGS. 6 and 7 are respectively a perspective view and a longitudinally sectioned view of a first detail of the above operating unit;

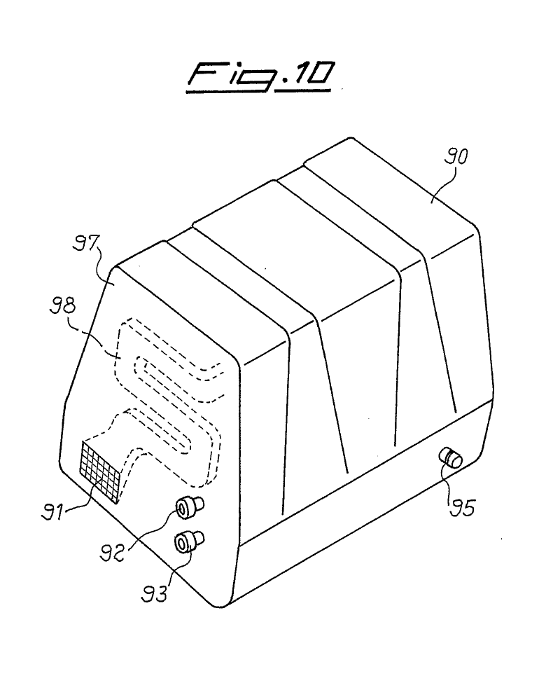

FIGS. 8 and 9 are respectively a perspective view and a longitudinally sectioned view of a second detail of the operating unit;

FIG. 10 shows the casing housing the operating unit according to the preceding figures.

With reference to the drawings, in them 1 denotes in its entirety an operating unit according to the invention intended for the production of electric power, desalination of water and air-conditioning of rooms.

The unit comprises an internal-combustion engine 2, which is preferably of the diesel type, supported by a base 3 in which seats 4, 5 and 6 are formed; the first two seats house respective osmotic membranes 8, 9 of the type known per se, for desalination and purification of water for drinking purposes, while the third seat houses an electric generator 10 (i.e. an alternator or a dynamo depending on whether the unit supplies alternating current or direct current) associated with a first evaporator 11 of an air-conditioning apparatus incorporated in the unit 1.

This first evaporator is supplied with part of the coolant fluid which circulates inside the apparatus and is in parallel arrangement with one or more evaporators 16 located in the rooms to be air-conditioned; the latter may be the cabins of a boat where the unit is installed or the rooms of a dwelling, as well as refrigerators or other facilities.

The base 3 can be of any suitable material even though preferably it is constructed using light metallic sections, for example of aluminium, rigidly assembled together; furthermore, in accordance with a preferred embodiment the seat 6 directly houses the stator of the electric generator 10, thereby reducing its weight since this solution allows the external casing of the generator to be eliminated.

Beside the engine 2 and above the seats 4, 5 for the osmotic membranes 8 and 9, on top of the base 3 there is a tube bundle heat exchanger 14 housing a condenser 15 of the air-conditioning apparatus.

This exchanger is supplied with seawater or water coming from outside the unit by means of a pump 17, but it may be excluded from the water flow path by means of a bypass pipe 18; water then comes out from the exchanger 14 and enters into a manifold 19 for the fumes of an exhaust 20, which will be referred to in detail below.

The water then comes out from the manifold 19 passing through a pipe 23, at the end of which it enters into a liquid/liquid exchanger 24 associated with the engine 2, for exchanging heat with the cooling liquid of the latter.

The seawater is then heated by passing into the exchanger 24 and at this point two situations may arise: namely, that desalinated water is required or not required.

In the first case, the seawater downstream of the exchanger 24 passes through a solenoid valve 30 and its flow is divided into two: one part goes towards the filters 31 and from here to a high-pressure pump 33 which supplies the osmotic membranes 8, 9. The other part instead goes to a discharge branch R1 where there is a compensation valve 32 which can be regulated so as to maintain predefined flow and pressure conditions upstream of the pump 33.

The latter is a pump of the volumetric type with pistons and is operated by a belt 35 and electromagnetic pulley 36 transmission which transmits the motive power to the pump 33 only when desalination of water is required.

If, on the other hand, no desalination is required, the compensation valve 32 is fully open and the water flow passes entirely through it (instead of being diverted also towards the pump 33), since it communicates downstream with the atmospheric pressure outlet, namely the exhaust 20, by means of a three-way valve 34.

The membranes 8, 9 separate the water flow coming from the pump 33, into desalinated water which goes towards a collection outlet and into a waste liquid having a high salt content which is discharged via a return branch R2 connected to the three-way valve 34 and the exhaust 20; the branch R2 also has, arranged along it, a pressure regulating valve 38 which maintains a predetermined pressure (of about 60 bars) on the membranes 8 and 9.

Furthermore, in this example of unit according to the invention, the possibility of tapping desalinated water and discharging it overboard is envisaged; for this purpose a solenoid valve 39 connected to the exhaust 20 by a tap channel S is situated downstream of the membranes 8 and 9.

As mentioned above, the operating unit 1 is used for air-conditioning; however, in accordance with a preferred embodiment thereof, it also cools the windings of the electric generator 10; this function, already described and claimed in another pending patent application, whose applicant is the same of that of the present application, is carried out by the first evaporator 11 of the air-conditioning apparatus, which is situated inside the seat 6 wherein the generator 10 is housed.

Obviously the air-conditioning apparatus includes a compressor 40, which is operated by the diesel engine 2 by means of a belt 41 and electromagnetic pulley 42 transmission in a manner known per se.

In this example the belt 41 also operates the supply pump 17 by means of a pulley 43 and, for an improved transmission of the motion to the various mechanisms, the belt 41 engages with a tensioning jockey wheel 44.

All these mechanical transmission devices are in turn actuated by a flywheel 47 keyed onto one end of the shaft of the motor 2, provided with respective races for the belts 35 and 41.

In accordance with a preferred embodiment, the high-pressure pump 33 and the compressor 40 are housed in respective compartments formed in a metallic structure 49 on which the pump 17 is also fixed: in this manner maintenance of the unit is facilitated because all of these elements can be easily reached from the outside and, in the case it is required to access the engine 2, the set of components shown in FIG. 4 may be easily disassembled so as to allow free access to the cylinder block.

Another important feature of the operating unit 1 consists in the fact that both the ends of the shaft of the engine 2 are used for operation of its components.

Indeed, in addition to the end where it is keyed, the flywheel 47 which operates the pumps 17, 33 and the compressor 40, the other end of the shaft of the engine 2 has keyed thereon a double-race pulley 52, which actuates the electric generator 10 by means of a belt 53 and pulley 54 first transmission, as well as a pump 55 inside the engine 2 for circulating its coolant liquid, by means of a belt 56 of a second transmission.

It can be easily understood that by using the two ends of the engine shaft it is possible to make the best possible use of the space available, thereby reducing the overall dimensions of the unit 1: indeed if the electric generator 10 were to be operated (via belts and pulleys) on the same side of the pump 17 and the compressor 40, it would have to be arranged above them, with the result of inevitably increasing the external dimensions of the unit. It should be taken into account that in such circumstances the evaporator would also have to be moved together with the generator.

The more compact configuration obtained using both ends of the shaft of the engine 2 also favours the reduction in the inertia relative to the axis of rotation X of the shaft (see FIG. 3) and the more balanced distribution of the load: this results in smaller dimensions of the shaft of the engine 2, which will therefore be lighter with respect to the same operating conditions.

Considering again the exhaust 20, its manifold 19 comprises a chamber 59 for collecting the fumes which is cooled externally by a jacket or cavity 60; the chamber 59 communicates directly with the engine 2 by means of the discharge ports 63.

The pump 17 supplies the external (sea, lake, river or other) water into an inlet 60 of the jacket 60, which then comes out from a nozzle 62 connected to the pipe 23; in this manner the jacket 60 cools the chamber 59 into which the hot fumes produced by the engine enter, thereby maintaining a low and constant temperature of the manifold 19.

This aspect must not be overlooked because the hot fumes may reach temperatures around 200-400° C., while the manifold 19 cooled in this way has an external temperature of about 70-90° C.; the manifold 19 is also fixed to the motor 2 by means of screws (not shown) engaging in special seats 64 which pass through the chamber 59.

When the engine 2 is in operation, the fumes from the collection chamber 59 pass into an outboard discharge duct 65; the latter is surrounded by another pipe 66 connected to the concentrate return branch R2 by means of a nozzle 67.

The pipe 66 therefore defines a cavity outside the duct for the fumes, which receives the water to be discharged supplied by the branch R1 and the concentrate which arrives from the membranes 8 and 9; the ends of the duct 65 and the pipe 66 then divide so that the fumes and the water are evacuated separately.

If it is considered that the manifold 19 also has the cooling jacket 60, it can be appreciated that inside the exhaust 20 the fumes are always cooled by means of heat exchange with water, without, however, being mixed therewith.

This avoids negative backpressure phenomena which hinder discharging of the fumes and require special measures.

Indeed, in conventional engines cooled with external water the fumes are mixed with the water upon discharge, in order to cool them: this restricts, however, their free evacuation and in fact often use is made of separators which divide the fumes from the water before conveying them into the open air.

In the present invention this is no longer necessary because the fumes are never in contact with the water, even though they are always cooled by it.

In accordance with a preferred embodiment of the invention, the manifold 19 of the exhaust is also provided with an expansion tank 70 for the liquid circulating inside the internal cooling circuit of the engine, which exchanges heat with the seawater in the exchanger 24.

It can be easily understood how this original solution satisfies the requirement that the expansion tank should be positioned at the highest point of the cooling circuit, since the manifold 19 is also situated in a high position with respect to the engine in order to favour discharging of the fumes upwards.

At the same time the incorporation of the expansion tank in the exhaust 20 is advantageous since it is a compact configuration which reduces the overall dimensions and eliminates the problems associated with the separate installation thereof; it should be noted that this particular configuration of the tank 70 is possible because the cavity 60 is situated between it and the manifold 19, thereby keeping the tank at a sufficiently low temperature.

Another innovative element of the operating unit according to the invention is shown in FIGS. 8 and 9.

It relates to an oil pan 80 applied at the bottom of the engine 2, and on top of the seats 5 and 6 of the base 3 of the unit; for this reason the bottom part of the pan is configured according to the profile of said seats.

The pan 80 is fixed to the engine block by means of screws or bolts applied along a flanged edge 81; obviously other fixing means may be envisaged as an alternative to the bolts.

In order to allow drawing of the lubricating oil when the operating unit is inclined in any direction and up to 25°, the pan 80 is configured internally as a step (see FIG. 9) with a top part 83 open upwards and having a mouth defined by the edge 81, and a bottom part consisting of a sump 85 for collecting the oil.

This sump is sufficiently narrow for the oil which collects there to reach always a level such as to guarantee efficient drawing from the bottom thereof, for any inclination of the pan 80 during navigation of the boat where the operating unit 1 is mounted.

It is interesting to note that this result is obtained by arranging the engine above the base 3 and therefore this does not require particular modifications to the structure of the unit.

A last innovative aspect of the operating unit 1 according to the invention consists in its external casing or cocoon 90, shown in FIG. 10.

As is known, all electric generators are housed in casings both for safety reasons (to avoid contact with mechanical moving parts or parts with electrical current) and for soundproofing reasons; these casings have walls which comprise a composite structure for damping the noise of the engine and which have openings for the air for cooling and operation of the engine. They have moreover connections for entry and discharging of the seawater together with the fumes and for conveying fuel to the engine.

In accordance with what is disclosed and claimed in the co-pending patent application already mentioned above, the casing 90 of the unit 1 of this invention is substantially closed, since it has only one intake opening 91 for the engine air and one opening (not shown in FIG. 10) for the discharge pipes 65 and 66 of the exhaust.

This is made possible by the fresh air produced by the first evaporator 11 which is used not only to cool the generator 10, but also to create an air-conditioned environment inside the casing 90; for this purpose the shaft 57 of the generator 10 is provided with an impeller 58 (see FIG. 3), which ensures forced ventilation of air licking the evaporator 11 and circulating inside the casing.

Obviously, for improved ventilation it is possible to use also additional impellers operated both by the shaft 57 of the alternator or by other shafts of the unit (for example that of the engine or one of the various pumps).

The casing 90 is also provided with connections 92 and 93 for the outward and return flow of the cooling fluid to the evaporator 16 (or the evaporators) outside the unit, as well as a connecting nozzle 95 for entry of the seawater; finally, means (sockets, cables or the like) not shown in the drawings are provided for electrical connection of the generator 10 to the on-board power grid or other electrical facility powered by the unit 1.

In accordance with this example of the invention, the thickness of the wall 97 of the casing 90 incorporates a channel 98 (shown in broken lines in FIG. 10) with a coiled extension, which connects the air opening 91 to a Helmholtz resonator 100 communicating with the air intake of the engine 2.

The channel 98 in combination with the resonator 100 allows in a surprising manner damping of the pressure waves generated by the intake of the engine 2, even when the frequency of these waves varies with the number of revolutions of the engine: this allows a reduction in the noisiness of the unit externally, with obvious benefits. It should be noted that generally Helmholtz generators are used to dampen the acoustic emissions without, however, combining them with channels such as the coiled channel considered here.

Function of the operating unit described hitherto occurs as follows.

The engine 2 actuates the feeding pump 17 for the water coming from outside the unit (from the sea but also from a lake or other source), which circulates first inside the heat exchanger 14, then inside the jacket 60 of the manifold 19 and finally inside the heat exchanger 24 of the cooling circuit of the engine 2; during these passages the water is heated respectively by the condenser 15 of the conditioning system, by the engine fumes and engine cooling liquid.

It must be pointed out, however, that heat exchange with the condenser 15 could be avoided in the case where air-conditioning of premises or activation of the electric generator 10 is not required, by causing the water to flow in the bypass branch 18.

If production of desalinated water is required, downstream of the condenser 24 the valve 30 is opened and a part of the water flow is conveyed to the osmotic membranes 8 and 9, keeping it at a controlled pressure by means of the compensation valve 32, which is partially closed so as to allow a part of the overall water flow to pass therethrough.

In general, closing of the valve 32 is regulated so as to maintain a pressure downstream thereof (1-2.5 bar) equal to that of the water suction of the high-pressure pump 33; however, the flow which reaches the latter is greater than that passing through the valve 32, by an amount varying from 3:1 to 3:2.

Furthermore, in accordance with a preferred embodiment, in the operating unit according to the invention the high-pressure pump 33 is switched off when the generator 11 produces electric power beyond a predefined level; for this purpose, a current measuring device controls the amperes supplied by the generator and when a predefined threshold value is detected, the electronic control system of the unit operates de-energization of the electromagnetic pulley 36 connected to the pump 33.

Owing to this control, the engine 2 is protected from overloading and is therefore able to operate at a uniform and not high number of revolutions; in this way its noise level is limited and at the same time maximum use is made of its torque which, as is known, is greater at a low number of revolutions, being a diesel engine.

In this connection it must be pointed that, owing to connection of the water flow path upstream of the pump 33 and downstream of the osmotic membranes 8, 9 by means of the discharge branch R1 where the valve 32 is situated, it is possible to carry out cleaning of the filter 31 by means of simple recirculation.

For this purpose it is sufficient to provide an additional branch R3 indicated by a broken line. in FIG. 5, which extends from downstream of the exchanger 24 to the intake of the pump 33; a valve 37 allows the flow to pass into the recirculation branch R3 while the valve 30 remains closed, so that the water passes through the filters 31 in the opposite direction to the normal direction (the pump 33 is closed) and is then discharged from the branch R1, leaving the compensation valve 32 open.

Downstream of the osmotic membranes 8, 9, desalinated water and brine with a high salt content come out: the former is collected in a storage tank (not shown in the drawings), while the latter returns to the exhaust 20 via the branch R2, the three-way valve 34 and the inlet nozzle 67 of the exhaust.

If, however, desalinated water is not required, the compensation valve 32 is completely open so that the water flowing out of the exchanger 24 passes freely into the discharge branch R1 and from here to the exhaust 20 where it is expelled, as already explained.

It should be merely pointed out that in this case the water quantity which passes into the branch R1 is the total water flow since the high-pressure pump 33 during this phase remains closed, forming in fact a valve which prevents the water from passing to the membranes.

From the foregoing description it can therefore be seen how the operating unit 1 achieves the object of the present invention.

Indeed, it allows maximum use of the seawater which serves either to cool the engine, the condenser and the exhaust, and to produce desalinated water.

This result is obtained by a single path starting with the pump 17 and ending in the exhaust 20 where discharge occurs, thereby reducing the installation work required in each case, such as seawater intakes, discharge outlets and the like.

In other words, with the operating unit according to the invention a complete integration between the functions of desalination and cooling of the engine (as well as condenser and exhaust) is obtained, so that it is no longer necessary to duplicate the water flow path in order to achieve either functions, as instead occurs in the state of the art considered above.

It is obvious that this simplifies the structure of the unit, preventing duplication of pumps, pipes, seawater intakes, discharge outlets and the like; the logical outcome is that the structure is now more compact and functional.

In this connection it is necessary to emphasize the important role of the discharge branch R1 and the compensation valve 32; indeed, as explained above, the water flow supplied by the pump 17 is split up at this branch and the main part is directed to the membranes while the remainder is directed to the discharge outlet.

The compensation valve 32 throttles the flow which passes into the discharge branch R1, keeping it at a predefined pressure equal to that of the flow which goes to the pump 33 (they are intercommunicating); this allows operation of a dynamic pump such as the supply pump 17, to be combined with operation of a volumetric pump like the high-pressure pump 33.

These pumps have indeed different operating characteristics: the former is suitable for high flow rates and low heads, while the latter is suitable for low flow rates and high heads.

This avoids that the volumetric pump 33 work with the same water throughput of the rotating pump 17, because in that case a mere change of the number of revolutions of the engine 2 which operates them by means of the drive belts (for example when the generator 10 and the compressor 40 are switched on or off), may result in malfunctions, cavitation and the like.

In the unit according to the present invention the dynamic pump 17 provides a flow rate which is greater than that required by the volumetric pump 33, and the excess water is discharged via the branch R1, thereby maintaining controlled pressure conditions owing to the compensation valve 32.

If in addition to all this, one considers the comments made in connection with use of both the ends of the shaft of the engine 2 in order to reduce the inertia, it can be understood how the present invention represents a major evolution in the sector of multi-purpose operating units.

Obviously changes to the invention with respect to the example considered above are possible.

One of these changes may concern the way in which the water flow is split upstream of the high-pressure pump 33, maintaining predefined pressure conditions at the intake thereof; indeed the branch R1 and the compensation valve 32 form a solution which is both simple and effective, but they might also be replaced by more complex means.

Furthermore it is clear that other possible changes may relate to the various mechanical drive systems for actuating the pumps, the compressor and the generator present in the unit 1; these drive systems may indeed be configured differently or also be replaced by other flexible drive systems (chains, toothed belts, etc.) or by gear mechanisms.

It must also be considered that the operating unit may perform other functions in addition to those described above, or perform them in a different manner.

For example the air-conditioning apparatus instead of being of the direct evaporation type as mentioned above, could be of the type where glycolated water circulates in fan coils; in this case the operating unit will have an exchanger for exchanging heat between the glycolated water and the coolant fluid, together with a pump for circulating said water.

This exchanger may be arranged in any suitable position, including in one of the seats 4 or 5 in place of the associated membrane 8 or 9; the pump for the glycolated water can be easily operated by the engine 2 using a drive belt system similar to those already mentioned.

Finally, in view of what has been already mentioned in the introduction, it must be emphasized that although in the example described reference has been made solely to desalination using osmotic membranes, the operating principles and the effects achieved by the invention are valid also in the case of filtration, ultrafiltration or other water treatment processes differing from desalination.

Moreover all of this does not exclude the possibility of subjecting the desalinated (or filtered) water to other treatments (with ultraviolet rays or equivalent means), so that it has a more pleasing taste or is ready for its intended use.

These treatments will also depend on the type of water which circulates within the unit, that may be seawater, fresh water (from lakes or rivers), brackish water or the like.

It must be pointed out that the operating unit according to the invention may be used not only on boats, but also in land vehicles or in all the other applications mentioned initially.

It just needs to be mentioned that the operating unit according to the invention also contains other filters, valves, sensors, means for regulating the engine, compressor, pumps, etc. and the like, necessary for correct operation thereof; all of these elements have not been described since they are not necessary for the understanding of the invention and because persons skilled in the art will know how to provide them in the most appropriate manner.

All of these variants nevertheless fall within the scope of the claims which follow.

1. Multi-purpose operating unit comprising an internal-combustion engine (2), an electric generator (10) operated by said motor, a first pump (17) for supplying water coming from outside the unit, filtering means (8, 9) for treating the water supplied from outside the unit, a second pump (33) for feeding the water to said filtering means, and a water flow path extending between said first and second pump (17, 33), characterized in that along said path the water flow is split so as to maintain predefined pressure conditions at the intake of the second pump (33).

2. Operating unit according to claim 1, comprising a discharge branch (R1) which departs from said water flow path and which has, arranged along it, a valve (32) that regulates the water flow inside said branch so as to control the pressure at the intake of the second pump (33).

3. Operating unit according to claim 1, wherein the water flow which reaches the second pump (33) is greater than that which passes through the discharge duct (R1).

4. Operating unit according to claim 1, wherein along the path between the first and the second pump (17, 33) the water exchanges heat to cool the engine, and wherein said discharge branch (R1) departs from the water flow path at a point downstream of heat exchange with the engine.

5. Operating unit according to claim 4, wherein the water along its flow path cools a manifold (19) for the fumes of the engine (2).

6. Operating unit according to claim 5, wherein the water before the heat exchange for cooling the engine (2), cools a condenser (15) of an air-conditioning apparatus associated with the unit.

7. Operating unit according to claim 1, wherein the filtering means comprises osmotic membranes, filtration membranes (8, 9) or the like.

8. Operating unit according to claim 7, comprising a return branch (R2) for a brine coming out from the membranes (8, 9), into which said discharge branch (R1) merges.

9. Operating unit according to claim 8, wherein said return branch (R2) terminates in connection with an exhaust (20) of the engine (2).

10. Operating unit according to claim 9, wherein the return branch (R2) of the brine contains an adjustable valve (38) that maintains a predefined pressure difference between upstream and downstream of the membranes (8, 9).

11. Operating unit according to claim 1, wherein the first pump (17) is of the dynamic type while the second pump (33) is of the volumetric type.

12. Operating unit according to claim 11, wherein both the first and the second pump (17, 33) are operated by the engine (2).

13. Operating unit according to claim 12, wherein the second pump (33) which supplies the membranes (8, 9) is switched off when the electric power produced by the generator (11) is greater than a predefined level.

14. Operating unit according to claim 1, wherein the electric generator (10) is cooled by means of ventilation with air cooled by heat exchange with a first evaporator (11) of the air-conditioning apparatus associated with the unit.

15. Operating unit according to claim 14, wherein the air-conditioning plant comprises a compressor (40) operated by the internal-combustion engine (2).

16. Operating unit according to claim 1, wherein the circuit containing the liquid for cooling the engine (2) comprises an expansion tank (70) incorporated in the exhaust (20).

17. Operating unit according to the preceding claims, claim 1, wherein both ends of the shaft of the internal-combustion engine (2) are provided with drive means (35, 36, 41, 42, 47; 52, 53, 54) for operating one or more of the following: the electric generator (10), the compressor (40) of the air-conditioning apparatus, the first and second pump (17, 33).

18. Operating unit according to claim 17, wherein said drive means comprises belts (35, 41, 53) and electromagnetic pulleys (36, 42, 52, 54).

19. Operating unit according to claim 1, wherein the internal-combustion engine (2) is supported by a base (3) provided with a seat (6) for housing the electric generator (10) and said first evaporator (11) of the air-conditioning conditioning apparatus.

20. Operating unit according to claim 19, wherein the seat (6) housing the generator (10) also forms its casing which contains the windings.

21. Operating unit according to claim 19, wherein the base (3) is made with metal sections.

22. Operating unit according to claim 20, comprising a pan (80) for the oil lubricating the engine (2), containing a collection sump (85) having a depth substantially equal to the height of the base (3) of the engine.

23. Operating unit according to claim 1, comprising an external casing (90) with an opening (91) in a wall for the entry of air, said wall containing a coiled channel (98) communicating with a Helmholtz resonator (100) associated with the air intake of the engine (2).

24. Operating unit according to claim 1, comprising an exhaust (20) with a manifold (19) for fumes having an external jacket (60) inside which water from the outside circulates and a fume evacuation duct (65) surrounded by a discharge pipe (66) which defines a cavity around it, from where the water circulating inside the unit is discharged.
